(19) United States
(12) Patent Application Publication
(10) Pub. No.: US 2024/0218945 A1
(43) Pub. Date: Jul. 4, 2024

(54) PIPELINE ASSEMBLY AND MANUFACTURING METHOD THEREFOR

(71) Applicant: Sri Skanda Rajah S. RATNAM, Kuala Lumpur (MY)

(72) Inventor: Sri Skanda Rajah S. RATNAM, Kuala Lumpur (MY)

(21) Appl. No.: 18/559,899

(22) PCT Filed: Sep. 8, 2021
(86) PCT No.: PCT/MY2021/050071

§ 371 Date: Nov. 9, 2023

(30) Foreign Application Priority Data
May 11, 2021 (MY) PI2021002637

(51) Int. Cl. F16L 9/17; F16L 9/12; F16L 9/18; F16L 9/22; F16L 25/01

(52) U.S. Cl. CPC F16L 9/17; F16L 9/121; F16L 9/18; F16L 9/22; F16L 25/01

(57) ABSTRACT

The present invention relates to a pipeline assembly and a manufacturing method therefore. The pipeline assembly (10, 20, 30, 40) comprises one or more tubular bodies (11, 21, 31, 41, 42) formed of one or more arc-shaped profile members (12, 22, 32, 33, 43, 44). Each arc-shaped profile member (12, 22, 32, 33, 43, 44) includes a tongue (12a, 22a, 32a, 33a) at one first edge and a groove (12b, 22b, 32b, 33b) at another first edge, wherein the first edges are opposite to one another.

### FIELD OF THE DISCLOSURE

The present invention relates broadly to the field of pipeline assembly. More particularly, the present invention relates to a pipeline assembly and a manufacturing method therefor.

### BACKGROUND

Large pipelines have been widely used for conveying/transporting various substances including water, sewage, crude oil, liquefied petroleum gas (LPG) and natural gas. Additionally, large pipelines are also used as protective enclosures for cables and the like. Usually, such pipelines are built by serially connecting multiple pipe modules made from concrete or metal, as they are strong enough to build pipelines of diameter greater than 2 meters and to withstand high differential pressures (>10 bars) exerted by the substances being transported.

Those pipe modules are too heavy to handle and transport. Furthermore, bulk manufacturing and bulk transportation are not possible due to their size and weight. On the other hand, pipe modules can be manufactured from plastic material which would reduce the weight of the pipe modules to a significant level, while minimizing corrosion of the pipelines.

Extrusion process is the mainly applied method for manufacturing plastic pipes, wherein raw plastic material is fed through a hopper into an extruder and the plastic feed is molten and pressurized into molten plastic, which is then forced through a die with an annular profile. Finally, the extruded pipe is solidified by spraying cold water over its surface. However, this process is inefficient for manufacturing huge pipes of diameter greater than 2 m.

There is still a need in the art for a pipeline assembly and a manufacturing method therefor, wherein longer and bigger pipelines are easier and quicker to build at the installation site. Furthermore, there is a need for pipeline assembly that is relatively simpler to transport and assemble in bulk.

### SUMMARY

The preset invention discloses a pipeline assembly, comprising a malleable sheet, wherein two first edges of the malleable sheet are clampable to each other by means of an interconnecting means to form a tubular body. The tubular body has a circular cross section, elliptical cross section or oval cross section.

In one aspect of the present invention, the interlocking means consists of a tongue and groove joint, wherein a tongue is formed at one of the first edges and a groove is formed at the other of the first edges. The tongue and the groove are clampable to one another by sliding or inserting the tongue into the groove.

Furthermore, the tongue and the groove are configured to form a hole between the tongue and the groove in a length direction when the tongue and the groove are clamped to one another. Preferably, the hole receives a liquid plastic or adhesive material to form an air-tight seal between the tongue and the groove. Alternatively, the hole receives one or more electrically conductive components to allow electrofusion welding between the tongue and the groove.

The method for manufacturing a pipeline assembly, comprising the steps of: bending a malleable sheet to form an arc-shaped profile member; and clamping two first edges of the sheet to one another by means of an interlocking means to form a tubular body.

In an alternate embodiment, the pipeline assembly comprises two or more malleable sheets, wherein one or both first edges of one of the sheets is clampable to a corresponding one of first edges of an adjacent sheet by means of two interlocking means resulting in a tubular body. Each interlocking means consists of a tongue and groove joint, wherein a tongue is formed at one of two edges clamped by the interlocking means and a groove is formed at the other of the edges.

In one aspect of the second embodiment of the present invention, the interlocking means is configured to press the first edges of one of the sheets against one another between the first edges of the other of the sheets to form an air-tight seal between the pressed edges.

The method for manufacturing a pipeline assembly, comprising the steps of: bending a first malleable sheet to form an arc-shaped profile member; and clamping two first edges of the sheet to corresponding first edges of a second sheet by means of two interlocking means to form a tubular body.

Optionally, the second sheet is bent before the clamping the first edges of the first sheet to the first edges of the second sheet.

In a third embodiment of the present invention, the pipeline assembly comprises two or more malleable sheets and a bracket, wherein two first edges of each malleable sheet is clampable to two edges of the bracket by means of two interconnecting means to form a tubular body with each sheet. Each interconnecting means consists of a tongue and groove joint.

In one aspect of the present invention, the tubular bodies are coplanar to one another. Preferably, the tubular bodies are coaxial to one another.

The method for manufacturing a pipeline assembly comprises the steps of: bending two or more malleable sheets to form an arc-shaped profile member with each sheet; and clamping two first edges of each sheet to one pair of edges of a bracket by means of at least two interlocking means to form a tubular body with each sheet.

Various objects, features, aspects and advantages of the inventive subject matter will become more apparent from the following detailed description of preferred embodiments, along with the accompanying drawing figures in which like numerals represent like components.

### BRIEF DESCRIPTION OF THE ACCOMPANYING DRAWINGS

In the figures, similar components and/or features may have the same reference numerals. Further, various components of the same type may be distinguished by following the reference numerals with a second numeral that distinguishes among the similar components. If only the first reference numeral is used in the specification, the description is applicable to any one of the similar components having the same first reference numeral irrespective of the second reference numeral.

FIG. 1 shows a perspective view of the pipeline assembly, in accordance with a first embodiment of the present invention.

FIG. 2 shows a front view of an arc-shaped profile member of the pipeline assembly, in accordance with a first embodiment of the present invention.

FIG. 3 shows a front view of a malleable sheet for forming the arc-shaped profile member of FIG. 2.

FIG. 4 shows a front view of the pipeline assembly, in accordance with a first embodiment of the present invention.

FIG. 4a shows a front view of fastening members of the pipeline assembly, in accordance with a first embodiment of the present invention.

FIG. 5 shows a front view of the fastening members before engagement, in accordance with a first embodiment of the present invention.

FIG. 6 shows a front view of the fastening members during engagement, in accordance with a first embodiment of the present invention.

FIG. 7 shows a perspective view of the pipeline assembly, in accordance with a second embodiment of the present invention.

FIGS. 8-10 shows front views of a profile member with different cross sections, in accordance with a second embodiment of the present invention.

FIG. 11 shows a perspective view of the pipeline assembly while engaging the profile members with one another, in accordance with a second embodiment of the present invention.

FIG. 12 shows a front view of the pipeline assembly including four profile members, in accordance with a second embodiment of the present invention.

FIG. 13 shows a perspective view of the pipeline assembly while engaging the four profile members with one another, in accordance with a second embodiment of the present invention.

FIG. 14 shows a front view of the pipeline assembly, in accordance with a second embodiment of the present invention.

FIG. 15 shows a perspective view of the pipeline assembly while engaging the profile members with one another, in accordance with a second embodiment of the present invention.

FIG. 16 shows a perspective view of the pipeline assembly with more than four profile members during engagement, in accordance with a second embodiment of the present invention.

FIG. 17 shows a front view of the pipeline assembly including more than four profile members, in accordance with a second embodiment of the present invention.

FIG. 18 shows a front view of an arc-shaped profile member, in accordance with a second embodiment of the present invention.

FIG. 19 shows a rear perspective view of an arc-shaped profile member, in accordance with a second embodiment of the present invention.

FIG. 20 shows a front view of the pipeline assembly with two tubular bodies, in accordance with a third embodiment of the present invention.

FIG. 20a shows a front view of an bracket of the pipeline assembly, in accordance with a third embodiment of the present invention.

FIG. 21 shows a top perspective view of the pipeline assembly, in accordance with a third embodiment of the present invention.

FIG. 22 shows a front view of the pipeline assembly with multiple brackets, in accordance with a third embodiment of the present invention.

FIG. 23 shows a perspective view of the pipeline assembly with multiple brackets, in accordance with a third embodiment of the present invention.

FIG. 24 shows a cross sectional view of the pipeline assembly with multiple reinforcement components installed between the two tubular bodies, in accordance with a third embodiment of the present invention.

FIG. 25 shows a front view of the pipeline assembly with three tubular bodies, in accordance with a third embodiment of the present invention.

FIG. 26 shows a flow diagram the method for manufacturing the pipeline assembly, in accordance with a first embodiment of the present invention.

FIG. 27 shows a flow diagram the method for manufacturing the pipeline assembly, in accordance with a second embodiment of the present invention.

FIG. 28 shows a flow diagram the method for manufacturing the pipeline assembly, in accordance with a third embodiment of the present invention.

### DETAILED DESCRIPTION

In accordance with the present disclosure, there is provided a pipeline assembly and a manufacturing method therefor, which will now be described with reference to the embodiments shown in the accompanying drawings. The embodiments do not limit the scope and ambit of the disclosure. The description relates purely to the embodiments and suggested applications thereof.

The embodiments herein and the various features and advantageous details thereof are explained with reference to the non-limiting embodiment in the following description. Descriptions of well-known components and processes are omitted so as to not unnecessarily obscure the embodiments herein. The examples used herein are intended merely to facilitate an understanding of ways in which the embodiments herein may be practiced and to further enable those of skill in the art to practice the embodiment herein. Accordingly, the description should not be construed as limiting the scope of the embodiment herein.

The description hereinafter, of the specific embodiment will so fully reveal the general nature of the embodiments herein that others can, by applying current knowledge, readily modify or adapt or perform both for various applications such specific embodiment without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It is to be noted that all the accompanying figures are for illustration purpose only, and the actual pipeline assembly may be configured with different dimensions and shapes.

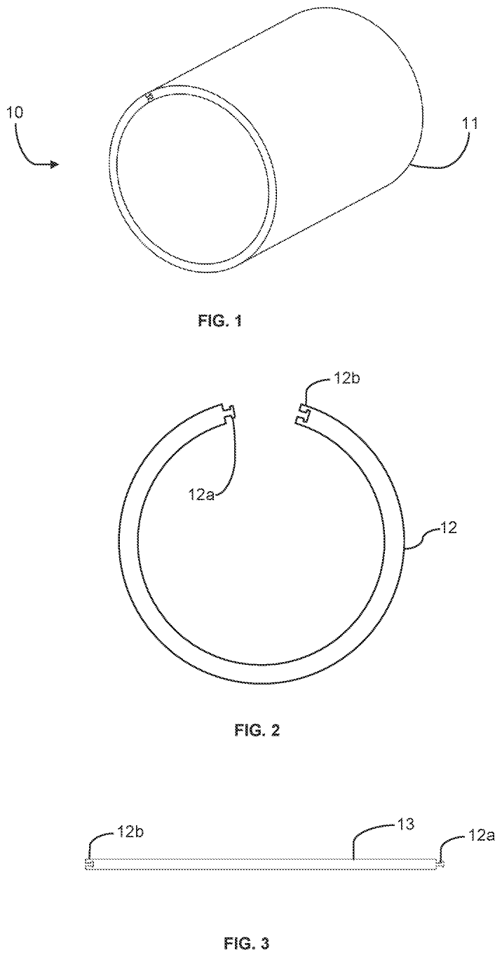

FIG. 1 shows a perspective view of the pipeline assembly in accordance with a first embodiment of the present invention. The assembly (10) includes a malleable sheet (13, shown in FIG. 3), wherein two first edges of the sheet (13) are clampable to each other by means of an interconnecting means resulting in a tubular body (11). Preferably, the interconnecting means consists of a tongue and groove joint, wherein a tongue (12a, shown in FIG. 2) is formed at one of the first edges and a groove (12b, shown in FIG. 2) is formed at the other of the first edges. Furthermore, the first edges are opposite to one another, preferably parallel in length direction. Alternatively, the first edges may be angled to one another.

The sheet (13) is bent to form an arc-shaped profile member (12, shown in FIG. 2), such that the tongue (12a) and the groove (12b) are brought closer to one another. Preferably, an arc measure of the arc-shaped profile member (12) is within a rage of 270-355°. The profile member (12) is configured to form the tubular body (11) when the tongue (12a) is slid into the groove (12b). Preferably, the malleable sheet (13) is bent through form bending process, thermoforming process or any other conventional bending process. The sheet is made of an elastomeric material such as plastics.

The tubular body (11) can be used for transporting any fluid or gaseous substance including but not limited to water, crude oil, liquefied petroleum gas (LPG), natural gas and the like. Furthermore, the present invention may also be applied for any large tubular structures including tunnel structures, subway structures, hyperloop tube structures and the like, capable of withstanding external differential pressure of about 30 bars and internal differential pressure of less than 10 bars.

Preferably, the tongue (12a) and the groove (12b) are configured to prevent one another from any movement perpendicular to a length direction of the tubular body (11), when the tongue (12a) and the groove (12b) are clamped to one another.

Optionally, one of the tongue (12a) and the groove (12b) includes a depression or dent, such that a hole is formed between the tongue (12a) and the groove (12b) in the length direction when the tongue (12a) and the groove (12b) are clamped to one another. A liquid plastic or adhesive material is injected into the hole to form an air-tight seal between the tongue (12a) and the groove (12b), so as to act as a permanent lock and also prevent leakage of the transported substance between the tongue (12a) and the groove (12b). Alternatively, an electrically conductive component can be inserted into the hole and electric current can be passed along the conductive component to allow electrofusion welding between the tongue (12a) and the groove (12b). Furthermore, the electrically conductive component may also be attached to one of the tongue (12a) and the groove (12b) while manufacturing the malleable sheet (13) and can be used for electrofusion welding after clamping the tongue (12a) and the groove (12b) to one another. Preferably, the electrically conductive component is a welding rod with embedded resistance wires to fuse surfaces of the joint.

Additionally, a handling member such as a knob, hook, loop, notch etc., can be attached on one or both surfaces of each or one of the first edges to allow handling the first edges while lifting, moving and sliding of the edges. Furthermore, the sheet (13) includes two second edges, wherein a dent (not shown) is formed at one second edge and a protrusion (not shown) is formed at the other second edge opposite to the third edge. The dent and the protrusion are configured to form a fitting alignment of the tubular body (11) with an adjacent tubular body (not shown), when multiple tubular body are connected in series to form the pipeline assembly (10).

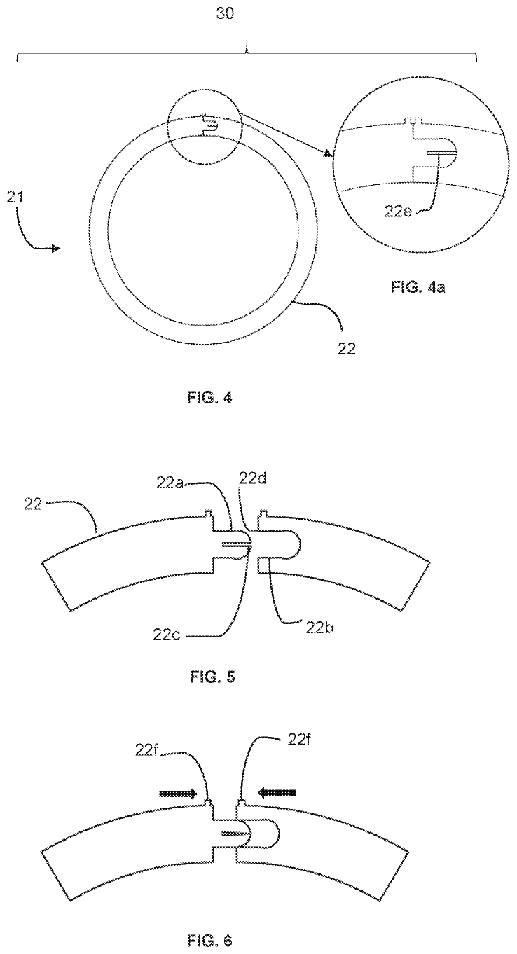

FIG. 4 shows a front view of the pipeline assembly in accordance with a first embodiment of the present invention. The assembly (20) includes a malleable sheet (not shown), wherein two first edges of the sheet are clampable to each other by means of an interconnecting means resulting in a tubular body (21). Preferably, the interconnecting means consists of a tongue and groove joint, wherein a tongue (22a, shown in FIG. 5) is formed at one of the first edges and a groove (22b, shown in FIG. 5) is formed at the other of the first edges.

The sheet is bent to form an arc-shaped profile member (22, shown in FIG. 5), such that the tongue (22a) and the groove (22b) are brought closer to one another. Preferably, the edges are clamped to one another by inserting the tongue (22a) into the groove (22b). Furthermore, the tongue (22a) is partially split to form a gap (22c, shown in FIG. 5), such that the splitted portion of the tongue (22a) can be selectively compressed.

When compressed, a maximum width of the splitted portion is less than or equal to a width of an entrance (22d, shown in FIG. 5) of the groove (22b). When not compressed, the maximum width of the splitted portion is greater than the width of the entrance (22d) of the groove (22b). Thereby, while inserting the tongue (22a) into the groove (22b), the splitted portion is compressed (as shown in FIG. 6), and when the tongue (22a) is in an engaged position (as shown in FIG. 4B), the splitted portion expands and securely engages with the groove (22b). By this way, the tongue (22a) and groove (22b) prevent one another from any movement perpendicular to a length direction of the tubular body (21), when the tongue (22a) and the groove (22b) are clamped to one another.

The gap (22c) in the tongue (22a) forms a hole with the groove (22b) in the length direction after the tongue (22a) and the groove (22b) are clamped to one another. A liquid plastic or adhesive material can be injected or pumped in through the hole to form a permanent air-tight seal and bond between the tongue (22a) and the groove (22b), so as to prevent any leakage of a transported substance between the tongue (22a) and the groove (22b).

Alternatively, an electrically conductive component can be inserted into the hole and electric current can be passed along the conductive component to allow electrofusion welding between the tongue (22a) and the groove (22b). Preferably, the electrically conductive component is a welding rod with embedded resistance wires to fuse surfaces of the joint. Additionally, a handling member (22f, shown in FIG. 6) such as a knob, hook, loop, etc., can be attached on one or both surface of each or one of the first edges to allow handling the edges while lifting, moving and sliding of the edges.

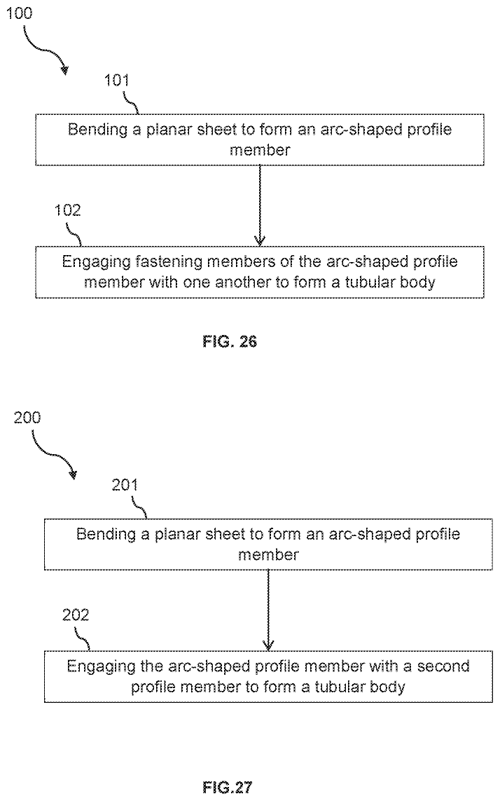

FIG. 26 shows a flow diagram of the method for manufacturing the pipeline assembly, in accordance with a first embodiment of the present invention. The method (100) comprises the steps of: bending a malleable sheet to form an arc-shaped profile member (101) and clamping two first edges of the sheet by means of an interconnection means to form a tubular body (102). Preferably, the tubular body has a circular cross section. Alternatively, the tubular body may have an elliptical cross section or oval cross section.

In a preferred embodiment, the malleable sheet is bent by form bending process or thermoforming process. Preferably, an arc measure of the arc-shaped profile members is within a range of 270-355°. After the form bending process or thermoforming process, the arc-shaped profile is hardened to retain the shape of the arc-shaped profile member.

Preferably, the interconnecting means consists of a tongue and groove joint, wherein a tongue is formed at one of the first edges and a groove is formed at the other of the first edges. The tongue and the groove are clamped to one another by sliding or inserting the tongue into the groove. A hole is formed between the tongue and the groove in a length direction when the tongue and the groove are clamped to one another. An air-tight seal between the tongue and the groove after clamping by attaching the tongue and the groove together.

Preferably, the tongue and the groove are attached together by introducing a liquid plastic or adhesive material through the hole. Alternatively, one or more electrically conductive components may be introduced through the hole for electrofusion welding between the tongue and the groove. Furthermore, one or more electrically conductive components may also be attached to one or both of the tongue and the groove along the length thereof during manufacturing of the malleable sheet or before clamping the tongue and the groove to one another.

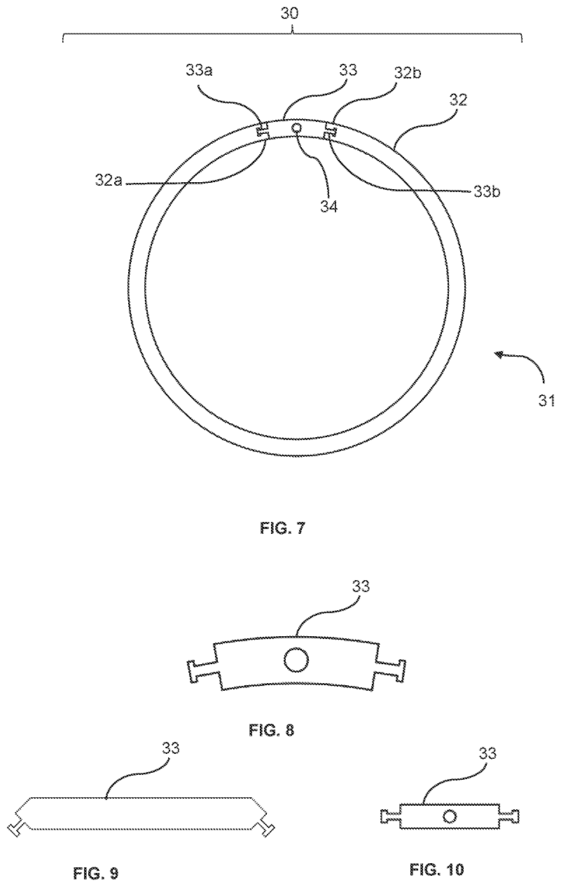

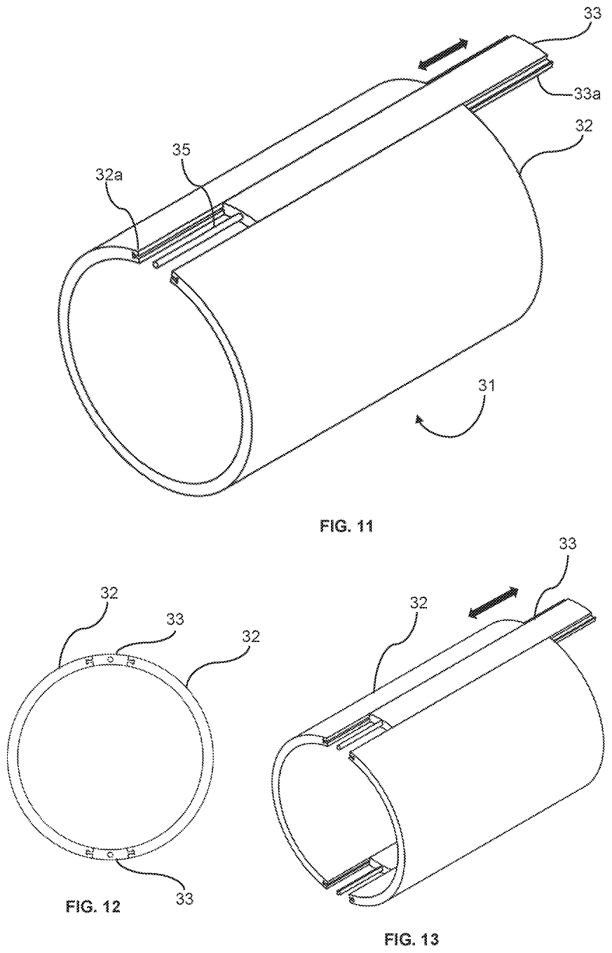

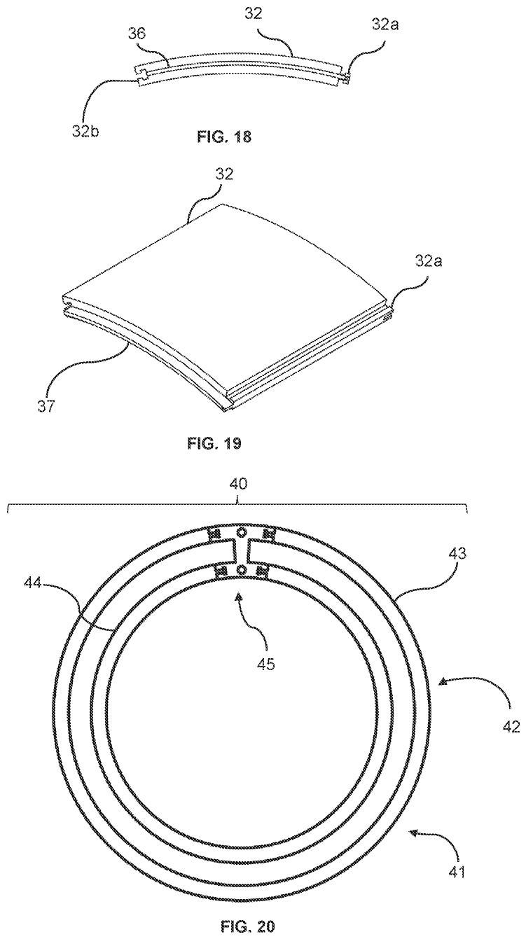

FIGS. 7-19 show different views of the pipeline assembly, in accordance to a second embodiment of the present invention. The pipeline assembly (30) comprises a first malleable sheet (not shown) and a second sheet (not shown), wherein each of two first edges of the first sheet is clampable to a corresponding first edge of the adjacent sheet by means of an interlocking means resulting in a tubular body (31).

Each interlocking means consists of a tongue and groove joint, wherein a tongue (33a, 33b) is formed at one of the two first edges clamped by the tongue and groove joint and a groove (32a, 32b) is formed at the other of the two first edges clamped by the tongue and groove joint.

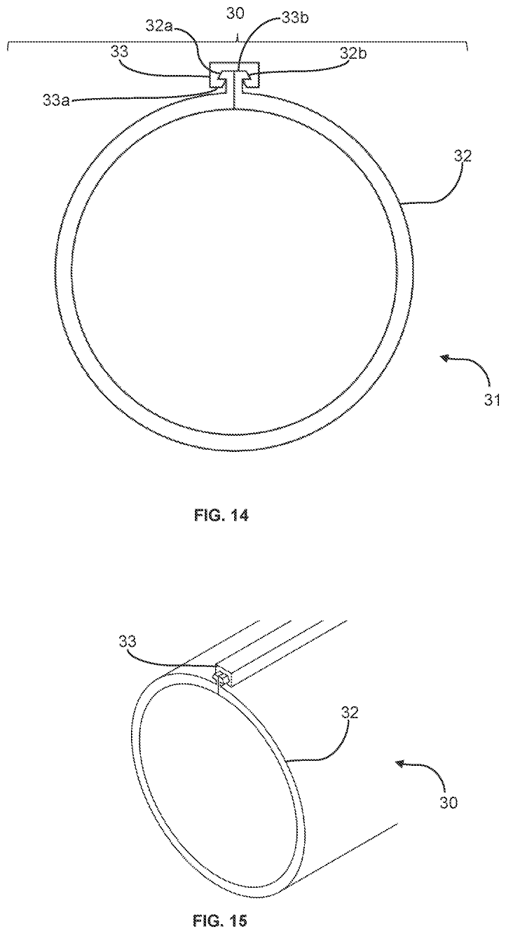

Preferably, each of the sheets is malleable and is bent to form an arc-shaped profile member (32, 33). Alternatively, only the first malleable sheet is bent to form the arc-shaped profile member (32), while the other profile member (33) is planar in shape, as shown in FIG. 10. In some other embodiment, the first edges of the profile member (33) is angled, as shown in FIG. 11, to clamp to the arc-shaped profile member (32). Furthermore, the profile member (33) may be formed as a hollow box with an open side and the tongue (33a) and the groove (33b) at open edges to press the first edges of the arc-shaped profile member (32) against one another, as shown in FIGS. 14 & 15.

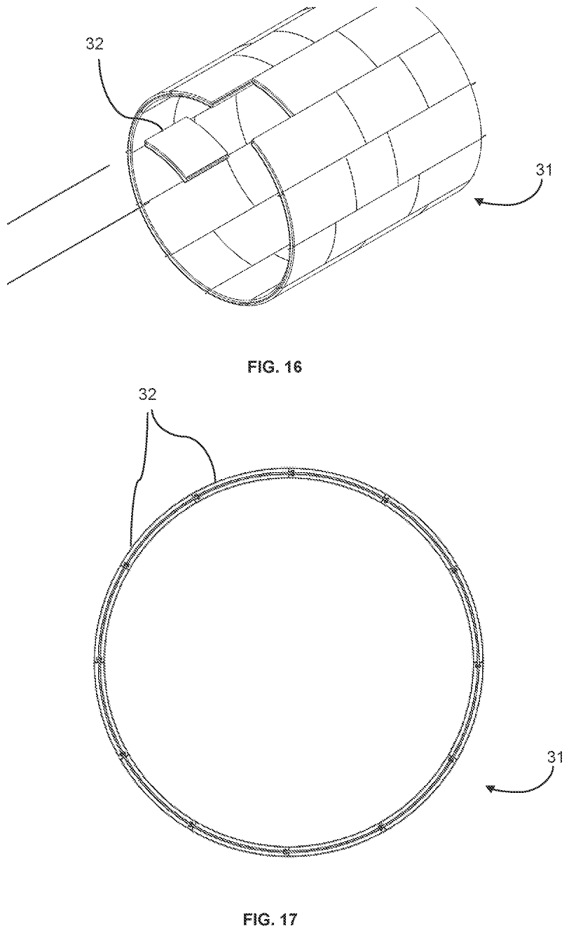

Alternatively, the pipeline assembly (30) comprises four malleable sheets (not shown), wherein the malleable sheets are bent to form two pairs of arc-shaped profile members (32, 33), as shown in FIGS. 12 & 13. Each arc-shaped profile members (32, 33) is clampable two adjacent arc-shaped profile members (32, 33) to form the tubular member (31). One pair of profile members (32) has longer arc length while the other pair of profile members (33) has shorter arc length. Optionally, each of the profile members (32, 33) has a different arc length and axial length, as shown in FIGS. 16 & 17. Additionally, one or both of the profile members (33) is planar in shape, while the profile members (32) are arc-shaped and are formed by bending a malleable sheet. Furthermore, each profile member (32, 33) has same radius of curvature. Alternatively, one or more of the profile members (32, 33) may have a different radius of curvature.

One or more of the profile members (32, 33) include one or more openings (not shown) and a door (not shown) for air-tight closure of each opening. Such openings may allow connectivity with another tubular member or access to an inner portion of the tubular member (31). Each sheet is made of different materials or of same material, preferably an elastomeric material such as plastics. Preferably, one or more of the sheets are made of transparent material, so that the pipeline assembly (30) can be used for algae farming or solar energy harvesting.

The profile members (32, 33) may have same thickness or different thickness as per requirements of particular applications. For example, when applied for transporting water or crude oil, the profile members (32, 33) at a bottom portion of the pipeline assembly (30) can be formed to be thicker as compared to the profile members (32, 33) at a top portion of the pipeline assembly (30). Similarly, a length of each profile member (32, 33) is different from or same as other profile members (32, 33).

One or more profile members (32, 33) include one or more reinforcement holes (34) in a length direction of the profile members (32, 33) for receiving a reinforcement member (35) to hold consecutive profile members (32, 33) in position, when the profile members (32, 33) are connected in series. Each profile member (32, 33) includes a dent (36, shown in FIG. 18) at a second edge and a protrusion (37, shown in FIG. 18) at an opposite second edge, such that the dent (36) and the protrusion (37) enable a fitting alignment of the profile members (32, 33) with the profile members (not shown) adjoining the second edges, when multiple profile members (32, 33) are connected in series.

When the tongues (33a, 33b) and the grooves (32a, 32b) are clamped to one another, each of the tongues (33a, 33b) and the corresponding groove (32a, 32b) prevent one another from any movement perpendicular to a length direction of the tubular body (31). Thereby, the tongues (33a, 33b) and the grooves (32a, 32b) allow the profile members (32, 33) to hold each other in in the direction perpendicular to a length of the profile members (32, 33) while allowing the profile members (32, 33) slide with respect to one another in the length direction, shown in FIG. 11. The profile members (32, 33) are configured to form the tubular body (31) when said profile members (32, 33) are engaged with one another.

Since the tubular body (31) is formed by bending the malleable sheets, a need for extruding the tubular body is avoided, while enabling manufacturing tubular bodies of different cross sections including circular, elliptical and oval, and of different shapes including cylindrical, conical, bent tube etc., by bending at different radius of curvatures and by altering a shape of the malleable sheets, respectively.

Furthermore, the malleable sheets can be manufactured in bulk in a simple manner. As compared to transporting tubular bodies, the malleable sheets can be stacked upon one another and easily transported on a vehicle to an installation site with minimal or no damage. Even if an edge of any of the malleable sheets is damaged, the damaged malleable sheet can be trimmed and used for forming the tubular body (31) and connected with another tubular body, as per requirements. Since each interconnecting means prevents movement of the profile members (32, 33) and the profile members (32, 33) are attached together in an air-tight manner, the tubular body (31) can retain its shape and no leakage of transported substance through the interconnecting means is possible.

One or both of the tongues (33a, 33b) and the grooves (32a, 32b) in each tongue and groove joint include a depression or dent, such that a hole is formed between the tongues (33a, 33b) and the grooves (32a, 32b) in each joint in the length direction when the profile members (32, 33) are clamped to one another. The hole is configured to receive a liquid plastic or adhesive material to form an air-tight seal between each tongue (33a, 33b) and the corresponding groove (32a, 32b) after clamping, so as to prevent leakage of the transported substance between the tongues (33a, 33b) and the corresponding grooves (32a, 32b). Alternatively, an electrically conductive component e.g. metallic rod or cable, can be inserted into the hole and electric current can be passed along the conductive component to allow electrofusion welding between the tongues (33a, 33b) and the corresponding grooves (32a, 32b). Furthermore, the conductive component can be attached to one of the tongue (33a, 33b) and the groove (32a, 32b) in each joint while manufacturing the corresponding malleable sheet or before clamping process and can be used for electrofusion welding after clamping.

FIG. 27 shows a flow diagram of the method for manufacturing the pipeline assembly, in accordance with a second embodiment of the present invention. The method (200) comprises the steps of: bending a first malleable sheet to form a first arc-shaped profile member (201) and clamping each of two first edges of the first sheet to a corresponding first edge of a second sheet by means of an interconnecting means to form a tubular body (202). Each interconnecting means consists of a tongue and groove joint, wherein a tongue is formed at one of the two first edges clamped by each tongue and groove joint and a groove is formed at the other of the two clamped edges. Preferably, the tubular body has a circular cross section. Alternatively, the tubular body may have an elliptical cross section or oval cross section.

Preferably, the first malleable sheet is bent by form bending process or thermoforming process. Preferably, an arc measure of the first arc-shaped profile member is within a range of 5°-355°. After the form bending process or thermoforming process, the arc-shaped profile is hardened to retain the shape of the arc-shaped profile member.

Preferably, the second sheet is also bent to form a second arc-shaped profile member and has an arc measure within a range of 5-355°. Furthermore, the arc measure of the second arc-shaped profile member may be same as or different from that of the arc measure of the first arc-shaped profile member. Alternatively, the second sheet is planar. Furthermore, the first edges of the second sheet are angled to properly clamp to the first edges of the first arc-shaped profile member.

Furthermore, the first arc-shaped profile can be formed by engaging two or more third arc-shaped profile members with one another, wherein each third profile member is formed by bending a third malleable sheet and each third malleable sheet includes a tongue at one first edge and a groove at an opposite first edge. An arc measure of each third profile member is same as or different from the remaining third profile members.

Preferably, the first edges of the first arc-shaped profile member are clamped to the first edges of the second profile member by sliding or inserting each of the tongues into the corresponding groove. An air-tight seal is formed between each of the tongues into the corresponding groove after clamping by attaching each of the tongues into the corresponding groove, wherein each tongue and groove joint is configured to form a hole with between the corresponding tongue and groove in a length direction when the tongues are clamped to the corresponding grooves.

Preferably, each of the tongues is attached to the corresponding groove by introducing a liquid plastic or adhesive material through each hole. Alternatively, one or more electrically conductive components may be introduced through the hole for electrofusion welding between the tongues and the corresponding grooves. Furthermore, one or more electrically conductive components may also be attached to one or both of the tongue and groove in each joint along the length thereof during manufacturing of the malleable sheets or before clamping each tongue into the corresponding groove. Likewise, each third profile member may also be attached with each adjacent third profile member by introducing the liquid plastic or adhesive material along or electrofusion welding of the corresponding tongue and groove joint.

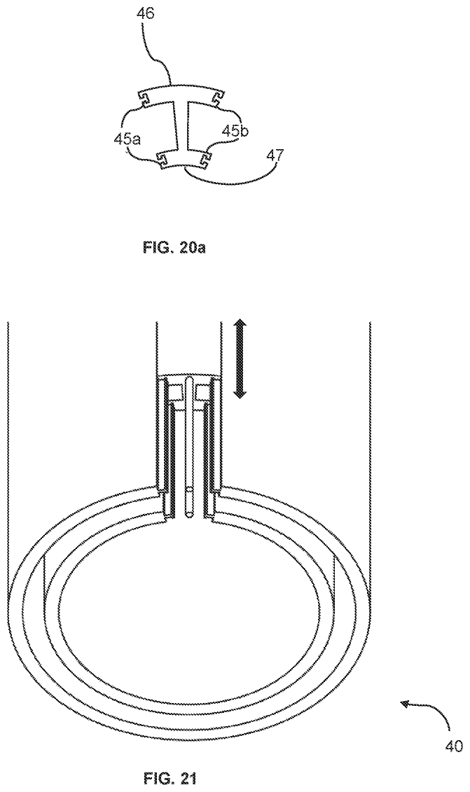

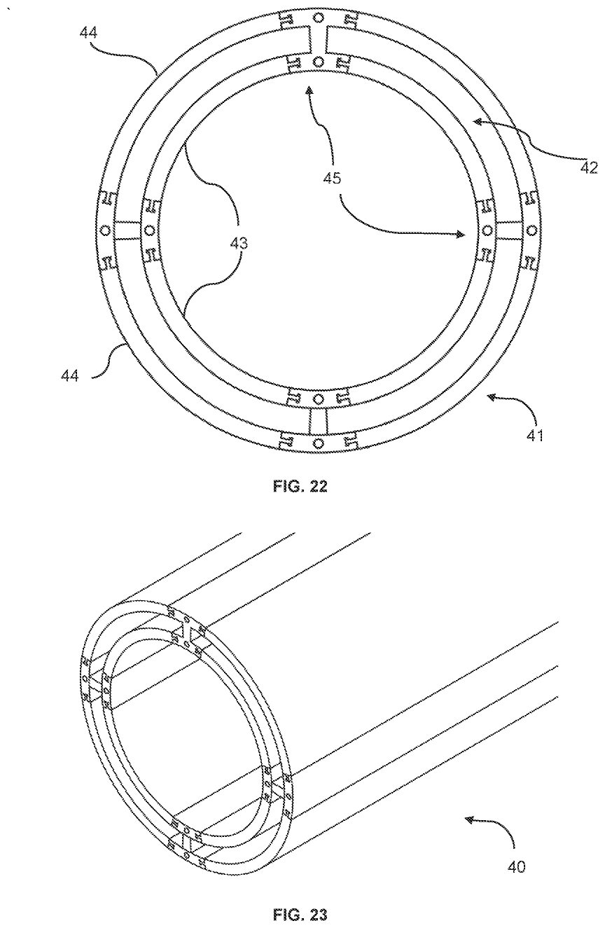

FIGS. 20-25 show different views of the pipeline assembly, in accordance with a third embodiment of the present invention. The pipeline assembly (40) comprises two or more malleable sheets (not shown) and a bracket (45) clampable between the sheets by means of multiple interconnecting means to form two or more interconnected tubular bodies (41, 42). Each sheet includes two first edges each clampable to a corresponding edge of the same bracket (45, as shown in FIGS. 20 & 21) or a different bracket (45, as shown in FIGS. 22-25) by means of an interconnecting means.

Preferably, the tubular bodies (41, 42) are coplanar to one another, more preferably coaxial to one another, as show in FIGS. 20 & 21-24. Alternatively, the pipeline assembly (40) may include more than two tubular bodies, as shown in FIG. 25, wherein the tubular bodies are coplanar to one another, while two of the tubular bodies are coaxial to one another. Preferably each tubular body (41, 42) has a circular cross section. Alternatively, the tubular bodies (41, 42) may also have elliptical cross section or oval cross section.

Similar to the interconnecting means of the first two embodiments of the present invention, each interconnecting means of the third embodiment consists of a tongue and groove joint. In each tongue and groove joint, a tongue (not shown) is formed at one of the two first edges clamped by the joint and the groove (not shown) is formed at the other first edge. Furthermore, each of the sheets is bent to form an arc-shaped profile member (43, 44) which is then clamped to the bracket (45) to form the tubular bodies (41, 42).

The bracket (45) includes a profile member (46, 47, shown in FIG. 20a) clampable to each of the arc-shaped profile members (43, 44) to form the tubular bodies (41, 42). Each profile member (46, 47) of the bracket (45) includes two edges with one groove (45a-45b, shown in FIG. 20a) at each edge for clamping to tongues (not shown) of the corresponding arc-shaped profile member (46, 47).

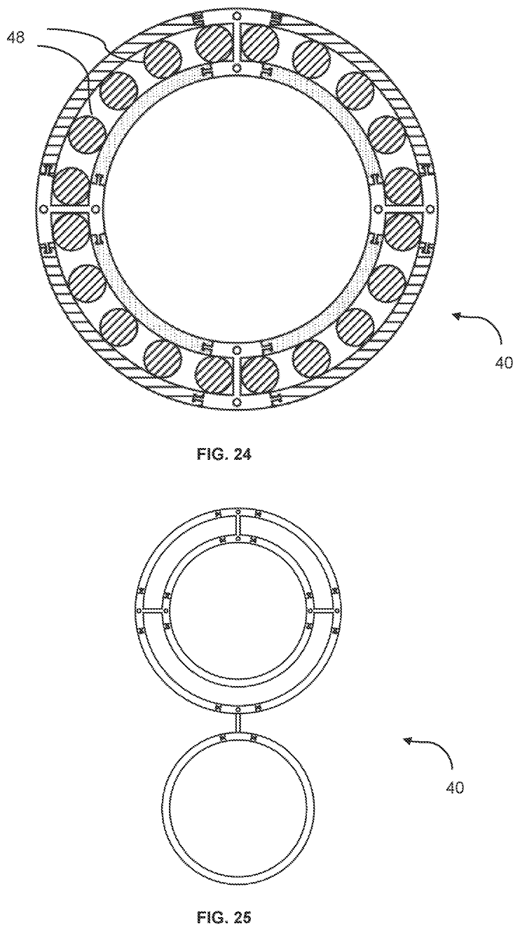

The profile members (46, 47) of the bracket (45) are connected to one another to form the bracket (45) as an I-shaped profile member, as shown in FIG. 20a. Optionally, one or both of the tubular bodies (41, 42) is formed of multiple arc-shaped profile members (43, 44) engaged with multiple brackets (45) between the corresponding arc-shaped profile members (43, 44), as shown in FIGS. 24 & 25. Each of the sheets and the bracket (45) is made of a different material or of same material, preferably elastomeric material such as plastics.

One or more reinforcement members (48, shown in FIG. 24) such as metallic cables, aircrete blocks and the like, are disposed between the tubular bodies (41, 42) to add strength and weight to the pipeline assembly (40) as well as to properly align and hold two or more consecutive tubular bodies together, when multiple similar pipeline assemblies are connected together in series. Alternatively, a space between the two tubular bodies (41, 42) can also be filled with sand, soil, any composite material and/or liquid or gaseous substances to allow the pipeline assembly (40) to submerge, half submerge or float when used for offshore applications. Furthermore, the tubular body (41) along with the reinforcement members (48) may protect any substance being transported or contained within the tubular body (42).

Since the tubular bodies (41, 42) are formed by bending the malleable sheets, a need for extruding the tubular bodies is avoided, while enabling manufacturing tubular bodies of different cross sections including circular, elliptical and oval, and of different shapes including cylindrical, conical, bent tube etc., by bending at different radius of curvatures and by altering a shape of the malleable sheets, respectively.

Furthermore, the malleable sheets and the brackets are simple to manufacture in bulk. As compared to transporting tubular bodies, the malleable sheets can be stacked upon one another and easily transported on a vehicle to an installation site with minimal or no damage. Even if an edge of any of the malleable sheets is damaged, the damaged malleable sheet can be trimmed and used for forming the tubular body and connected with another tubular body, as per requirements. Since the fastening members prevent movement of the engaged fastening members and are attached together in an air-tight manner, the tubular body can retain its shape and no leakage of transported substance through the fastening members is possible.

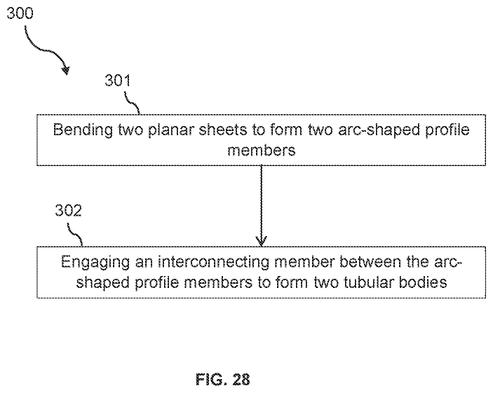

FIG. 28 shows a flow diagram of the method for manufacturing the pipeline assembly, in accordance with a third embodiment of the present invention. The method (300) comprises the steps of: bending two or more malleable sheets to form two or more first arc-shaped profile members (201) and clamping one or more brackets between the first arc-shaped profile members by means of multiple interlocking means to form two or more a tubular bodies (202). The bracket includes two or more profile members and each profile member of the bracket includes a tongue at one edge and a groove at an opposite edge. Preferably, each tubular body has a circular cross section. Alternatively, one or more of the tubular bodies may have an elliptical cross section or oval cross section.

In a preferred embodiment, each malleable sheet is bent by form bending process or thermoforming process. Preferably, an arc measure of the arc-shaped profile members is within a range of 270-355°. After the form bending process or thermoforming process, the arc-shaped profile member is hardened to retain the shape of the arc-shaped profile member.

Preferably, each profile member of the bracket is also arc-shaped and has an arc measure within a range of 5-10°. Alternatively, the profile members of the bracket are planar shaped with two profiled edges. Furthermore, the profile members are connected to one another by a rigid member to form the bracket as an I shaped profile member.

Each interconnecting means consists of a tongue and groove joint, wherein a tongue is formed at one of the two first edges clamped by the joint and the groove (not shown) is formed at the other first edge. Preferably, each profile member of the bracket has two edges with a groove at each edge. Each groove is clamped to a tongue of the corresponding arc-shaped profile member by sliding engagement or by inserting the tongue into the groove.

An air-tight seal is formed at each tongue and groove joint by attaching the corresponding tongue and groove with one another, wherein each tongue and groove joint is configured to form a hole between the corresponding tongue and groove in a length direction when clamped to one another.

Preferably, each tongue and the corresponding groove are attached together by introducing a liquid plastic or adhesive material through the hole. Alternatively, one or more electrically conductive components may be introduced through the hole for electrofusion welding between the tongues and the corresponding grooves.

Furthermore, one or more electrically conductive components may also be attached to one or both of the tongue and the groove of each tongue and groove joint along the length thereof during manufacturing of the malleable sheet or before the clamping step.

Even though the above embodiments show the present invention including a tongue and groove joint for clamping the edges to form the tubular body, it is to be understood that any joints that allow air-tight sealing by means of sliding or inserting action can be used. Similarly, one or more arc-shaped profile members can be made of different thickness, arc length, arc measure, radius of curvature and length. Optionally, one or more profile members or brackets may be attached with one or more loops, anchors and/or clamp members for hanging/anchoring the pipeline assembly to a support member such as seabed, concrete platform, ground surface, wall surface and the like.

Furthermore, one or more profile members may configured to be transparent, so as to enable the transported substance to be visible from outside the tubular bodies. By configuring the transport profile members, it is also possible to focus sunlight over contents within the pipeline assembly by configuring a refractive index and/or curvature of the profile members as per requirements, for example requirements of algae farming and solar power harvesting.

The terminology used herein is for the purpose of describing particular example embodiments only and is not intended to be limiting. As used herein, the singular forms “a”, “an” and “the” may be intended to include the plural forms as well, unless the context clearly indicates otherwise.

The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups thereof.

The use of the expression “at least” or “at least one” suggests the use of one or more elements, as the use may be in one of the embodiments to achieve one or more of the desired objects or results.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1-29. (canceled)

30. A pipeline assembly, comprising:
a. at least one malleable sheet with two first edges opposite to one another; and
b. an interlocking means capable of clamping said first edges of said sheet to each other resulting in a tubular body, wherein said interlocking means consists of a tongue and groove joint, wherein a tongue is formed at one of said first edges and a groove is formed at the other of said first edges,
characterized in that said tongue is partially split, such that said split portion of said tongue is selectively compressible for entering in or exiting said groove and is configured to form a hole between said tongue and said groove in a length direction of said tubular body when said tongue and said groove are clamped to one another, wherein said hole is capable of receiving a liquid plastic, adhesive material or an electrofusion component.

31. The pipeline assembly of claim 30, wherein said tongue and said groove are clampable to one another by sliding or inserting said tongue into said groove.

32. The pipeline assembly of claim 30, wherein said electrofusion component is at least one electrically conductive component to allow electrofusion welding between said tongue and said groove.

33. The pipeline assembly as claimed in claim 30, wherein said tubular body has a circular cross section, elliptical cross section or oval cross section.

34. The pipeline assembly of claim 30, wherein said sheet includes at least one reinforcement hole in a length direction of said sheet for receiving a reinforcement member.

35. The pipeline assembly of claim 30, wherein said sheet is made of an elastomeric material.

36. The pipeline assembly of claim 35, wherein said elastomeric material includes plastics.

37. A method for manufacturing a pipeline assembly, comprising the steps of:
bending at least one malleable sheet to form an arc-shaped profile member; and
clamping two first edges of said sheet to one another by means of an interlocking means to form a tubular body, wherein said interlocking means consists of a tongue and groove joint, wherein a tongue is formed at one of said first edges and a groove is formed at the other of said first edges,
characterized in that said clamping said first edges includes:
a. forming a hole between said tongue and said groove in a length direction of said sheet, wherein said tongue is partially split, such that said split portion of said tongue is selectively compressible for entering or exiting said groove and configured to form said hole when said tongue is clamped and said groove are clamped to one another; and
b. introducing a liquid plastic, adhesive material or electrofusion component through said hole.

38. The method of claim 37, wherein said step of clamping includes sliding or inserting said tongue into said groove.

39. The method of claim 37, wherein said electrofusion component includes at least one electrically conductive component for electrofusion welding between said tongue and said groove.

40. A pipeline assembly, comprising:
a. at least two malleable sheets; and
b. an interlocking means capable of clamping at least one of two first edges of one of said sheets to a corresponding edge of an adjacent sheet resulting in a tubular body, wherein each interlocking means consists of a tongue and groove joint, wherein a tongue is formed at one of two edges clamped by means of the interlocking means and a groove is formed at the other of said clamped edges,
characterized in that each tongue is partially split, such that said split portion is selectively compressible for entering or exiting said groove and is configured to form a hole between said tongue and said groove in a length direction when said tongue and said groove are clamped to one another, wherein said hole is capable of receiving a liquid plastic, adhesive material or an electrofusion component.

41. The pipeline assembly of claim 40, wherein each interlocking means is configured to press said first edges of one of said sheets against one another between said first edges of the other of said sheets to form an air-tight seal between said pressed edges.

42. A method for manufacturing a pipeline assembly, comprising the steps of:
i. bending at least one first malleable sheet to form an arc-shaped profile member; and
ii. clamping two first edges of said first arc-shaped profile member to corresponding first edges of a second sheet by means of two interlocking means to form a tubular body, wherein each interlocking means consists of a tongue and groove joint, wherein a tongue is formed at one of two edges clamped by means of said interlocking means and a groove is formed at the other of said clamped edges, characterized in that said clamping said first edges includes:
a. forming a hole between a tongue and a groove of each tongue and groove joint in a length direction of said sheet, wherein each tongue is partially split, such that said split portion is selectively compressible for entering or exiting said groove and is configured to form a hole between said tongue and said groove in a length direction when said tongue and said groove are clamped to one another; and
b. introducing a liquid plastic, adhesive material or electrofusion component through each hole.

43. The method of claim 42, further comprising the step of bending said second sheet to form a second arc-shaped profile member before the clamping step.

44. A pipeline assembly, comprising:
a. at least two malleable sheets;
b. at least one bracket clampable between said sheets by means of multiple interlocking means to form at least two interconnected tubular bodies, wherein each interconnecting means consists of a tongue and groove joint, wherein one of tongue and groove of each interconnecting means is formed at an edge of one of said sheets, while the other of said tongue and groove is formed at an edge of said bracket corresponding to said edge of said sheet,
characterized in that each tongue is partially split, such that said split portion is selectively compressible for entering or exiting said groove and is configured to form a hole between said tongue and said groove in a length direction when said tongue and said groove are clamped to one another, wherein said hole is capable of receiving a liquid plastic, adhesive material or an electrofusion component.

45. The pipeline assembly of claim 44, wherein said tubular bodies are coplanar to one another.

46. The pipeline assembly of claim 45, wherein said tubular bodies are coaxial to one another.

47. The pipeline assembly of claim 44, wherein each of said malleable sheets and said bracket is made of an elastomeric material.

48. The pipeline assembly of claim 47, wherein said elastomeric material includes plastics.

49. A method for manufacturing a pipeline assembly, comprising the steps of:
i. bending at least two malleable sheets to form two arc-shaped profile members;
ii. clamping at least one bracket between said first arc-shaped profile members by means of multiple interlocking means to form at least two interconnected tubular bodies, wherein each interconnecting means consists of a tongue and groove joint, wherein one of tongue and groove of each interconnecting means is formed at an edge of one of said sheets, while the other of said tongue and groove is formed at an edge of said bracket corresponding to said edge of other of said sheets, characterized in that said step of clamping said bracket includes:
forming a hole between a tongue and a groove of each tongue and groove joint in a length direction of said sheet, wherein each tongue is partially split, such that said split portion is selectively compressible for entering or exiting said groove and is configured to form a hole between said tongue and said groove in a length direction when said tongue and said groove are clamped to one another; and
introducing a liquid plastic, adhesive material or electrofusion component through each hole.

50. An interlocking means for clamping two edges, comprising:
a. a tongue formed at one of said edges;
b. a groove formed at the other of said edges; and
c. a sealing component for sealing said edges,
characterized in that said tongue is partially split, such that said split portion of said tongue is selectively compressible for entering in or exiting said groove and is configured to form a hole between said tongue and said groove in a length direction of said edges when said tongue and said groove are clamped to one another, wherein said hole is capable of receiving said sealing component.

51. The interlocking means of claim 50, wherein said sealing component is at least one of:
at least one liquid plastic;
an adhesive material; and
at least one electrofusion component.

52. The interlocking means of claim 51, wherein said electrofusion component includes at least one electrically conductive component for electrofusion welding between said tongue and said groove.
